(19) United States
(12) Patent Application Publication
(10) Pub. No.: US 2010/0282667 A1
(43) Pub. Date: Nov. 11, 2010

(54) Method for Producing a Support Part and Filter Element

(76) Inventors: Michael Sakraschinsky, St. Ingbert (DE); Günther Müller, Salem (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/086,482

(22) PCT Filed: Nov. 21, 2006
(86) PCT No.: PCT/EP2006/011137

§ 371 Date: Jul. 20, 2010

(30) Foreign Application Priority Data
Dec. 19, 2005 (DE) 10 2005 060 612.1

(51) Int. Cl. B01D 29/11; B23P 15/16

(52) U.S. Cl. 210/483; 29/896.62

(57) ABSTRACT

The invention relates to a method for producing a support part, in particular, for use with a filter element. Said support part is shaped in the form of a support tube (10) provided with through holes for fluid (12), the periphery thereof forming a bearing surface (14) for the filter material, wherein at least one annular shaped head (16) is applied, separating the bearing surface (14) into partial bearing surfaces (18). By reducing the free bead cross-section and by forming a support ring (24), the adjacent opposite bead edges (22) of the respective associated bead (16) are arranged on top of each other in order to achieve high stability and functional reliability. The invention also relates to a filter element which is produced according to said method. method.

The invention relates to a method for producing a support part, in particular for use with a filter element which, provided with fluid passages, is shaped into a support tube which on the peripheral side forms a contact surface for a filter material, into which at least one bead which divides the contact surface into component contact surfaces is annually formed. The invention furthermore relates to a filter element produced using this method, with a support part.

DE 102 56 743 A1 discloses a filter element for fluids with a hollow body as the support part which has fluid passages, which is surrounded by filter material, which defines an inner filter cavity for filtered fluid, and which is used as a carrier for a spool of the filter material which has been wound on it with a plurality of turns, in the form of a filter strip. In the known solution there is a spool which is made at least in two parts, with an inner part which is formed by a first filter strip which with its start adjoins the hollow body, which surrounds the latter with a plurality of turns, and with an outer second part which is formed by a second filter strip which is detachably connected with its start to the end of the first filter strip and which surrounds the first filter strip with a plurality of turns. The known solution allows improved filter operating behavior, in particular unwinding processes caused by fouling can be controlled by the differential pressure.

In addition to the indicated filter spool as filter material, DE 10 2004 061 078, which was published at a later date, discloses a filter material for a filter element with at least a first structural layer with a definable surface area and definable filter properties, such as filter fineness, there being a structural layer which has at least one other definable filter property on one of the top sides of the first structural layer or between them, and with a definable surface area which is different from the surface area of the first structural layer. The indicated structural layers as the filter material are made from strips of different length and in particular are pleated, preferably with the same type and number of folds. Comparably to the aforementioned solution, a type of prefilter and main filter can be designed for the filter element above the different pleated structural layers, and the main filter can be designed, viewed in terms of fluid permeability, such that it passes large amounts of fluid with acceptable dirt holding capacity which can then be improved by high filter fineness of the prefilter. In this known solution the pleated structural layers also extend around the outer periphery of the support tube as a support part of the filter element.

It is common to all the aforementioned known solutions that the respective filter material used is supported on a support part in the form of a support tube with fluid passages, made in the form of a perforation, depending on the configuration of the filter element support tubes in different materials, wall thicknesses, holes, as well as divisions and types of surface protection being produced for different stresses. Since the diameter of the holes (perforations) which form the fluid passages depends on the wall thickness of the tube, for high stresses greater wall thicknesses and thus also correspondingly large holes, that is, fluid passages with large passage cross sections, are required.

During filtration, the fouled fluid first flows through the inserted filter material of the filter element, dirt being retained, and the cleaned fluid flows through the fluid passages of the support tube and is drained out of the filter device on the inside of the support tube. In this filter operation therefore a differential pressure forms between the outside of the filter element and the inside of the support tube, with the result that parts of the filter material or of the filter mat (filter spool) are pressed into the fluid passages and thus can be damaged. This effect which damages the filter material can be prevented by an additional screen cylinder, such as metal gauze, being pulled over the outside diameter of the support tube or the filter material itself being held in intermediate wire gauze coatings; only then is in necessary to provide the support tube with very high wall thicknesses in order to prevent, at correspondingly high pressure differences, the support tube from collapsing, which in an extreme case leads to tearing of wall parts and therefore to failure of the filter element.

In order now to be able to reduce the wall thickness of the support tube and thus also the diameter of the fluid passages for such high requirements, in order to arrive at high stiffness and strength values, it has already been proposed in practice that so-called support rings be placed and attached within the support tube. On the one hand, this is very complex in installation and moreover has the disadvantage that when the support rings are pressed in, a burr can form on the inside of the support tube, since the ring must move over the burr from punching which is located to the inside. Another disadvantage arises if the support tube must subsequently be provided with surface protection, for example, in the form of a corrosion-inhibiting coating or the like. In this case the two parts, the support tube and the support rings, must be coated separated and then mounted; this in turn is time-consuming and expensive, or the support rings must first be mounted and then the combination must be coated; this leads to partially stain-like surface protection also collecting in the gaps between the support part and the assignable support ring; running out toward the bottom and resulting in the formation of corrosion. In order to mitigate these disadvantages, in turn it has been proposed in practice that the wall thickness of the support tube be reduced, without pressing-in additional rings, by impressing peripheral beads into the support tube. These stiffening beads lead to an increase of strength and stiffen the support tube combination; but weakening of the support tube material occurs in this way by the notch action of the bead which is made V-shaped and which remains in this way, with the result of possible failure by crack formation.

On the basis of this prior art, the object of the invention is to further improve the known methods for producing a support part and the filter elements produced according to them such that the production and assembly costs are reduced and higher stability and operating reliability are achieved. This object is achieved by a process with the features of claim 1 in its totality and a filter element with the features of claim 9.

In that according to the invention while reducing the free bead cross section and with the formation of a support ring, the flanks of the respectively assignable beads, which flanks are adjacently opposite one another, are placed on top of one another, the damaging notching action for V-shaped beads in the base of the support tube is avoided, since by reducing the possible wedge cross section the bead base is rounded. Furthermore, the adjacent bead flanks can be supported both in the axial direction of the support part in the form of the support tube and also mutually in the radial direction; this leads to stiffening of the overall combination with the respective partial contact surfaces of the support tube.

Furthermore, the tendency of the support tube to collapse is effectively counteracted by the support ring which has been formed in this way and damaging effects on the material of the support tube are avoided as a result of the possible large transitions. It has been found that with the solution according to the invention a combination which is highly resistant to bulging can be implemented, which moreover can be economically produced and analogously assembled in the form of the complete filter element. In particular the support rings which have been placed in this way do not lead to burr formation for the other support tube material; this could otherwise promote damaging notching action. Furthermore, it has been shown that due to the closed support ring structure, coating of the support tube does not pose problems, since in particular at this point the support rings constitute an integral component of the otherwise tubular support part with its respective partial contact surfaces. Furthermore, in this respect the existing corrosion danger is effectively counteracted if sheet metal materials should be used for the support part.

Other advantageous embodiments of the solution according to the invention are the subject matter of the other dependent claims.

The process according to the invention will be detailed below using one embodiment as shown in the drawings. The figures are schematic and not to scale.

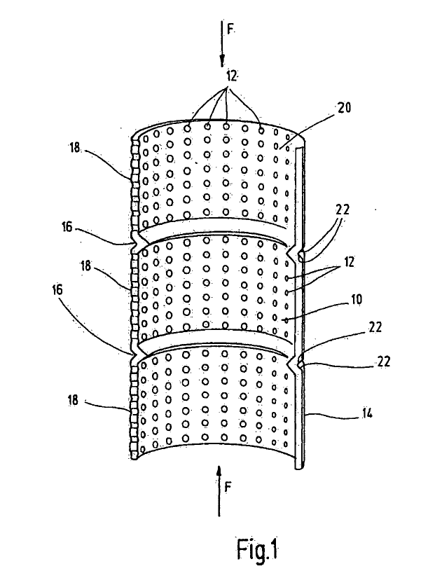

FIG. 1 shows a partial extract of a tubular support part in a preliminary process step,

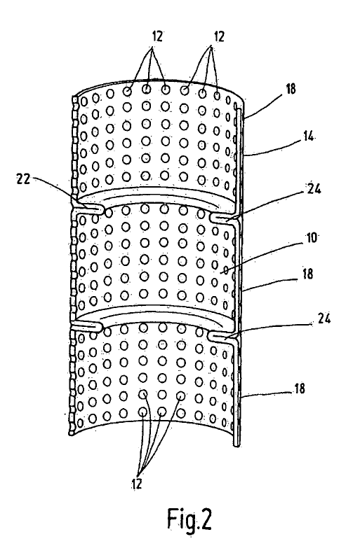

FIG. 2 shows a representation corresponding to FIG. 1 after completing the process according to the invention.

The process according to the invention which is to be described is used to produce a support part, in particular for use with a hydraulic filter element which is readily available on the market in a plurality of embodiments. Reference is made here by way of example to the disclosure contents of DE 10 2004 005 202 and to DE 102 56 743. Another filter element with electrically conductive contact-making parts is shown by way of example in DE 10 2004 061 078. In this respect the teaching according to the invention will be detailed below using the support part shown in FIGS. 1 and 2. It has a cylindrical support tube 10 which is provided with fluid passages 12 which are located in the gaps and cells and which penetrate the support tube 10 to carry fluid. These fluid passages 12 are made in the support tube 10 in the form of perforations which, in addition to a cylindrical cross sectional surface, can also be shaped differently and can also be obtained, for example, as an oval execution.

The support tube 10 on the outer peripheral side has a contact surface 14 for pleated filter material which is not detailed or a cylindrical filter spool. On the outer peripheral side, beads 16 which run annularly and which divide the contact surface 14 into three component contact surfaces 18 with essentially the same installation height are made in the pertinent contact surface 14. The free bead cross section shown in FIG. 1 is made V-shaped or wedge-shaped, the wedge extending to the inside 20 of the support tube and the two adjacent free bead flanks 22 discharge essentially flush on the top side of the contact surface 14 and therefore on the outer periphery of the support part.

If in the longitudinal direction of the support tube 10 at this point a force F is applied oppositely to the ends of the support tube 10, the free bead cross section shown in FIG. 1 is reduced with the formation of the respective support ring 24 (cf. FIG. 2) which extends in this respect in the form of a blister on the inside of the support tube 10 which is used there with its free inside cross section to remove filtered fluid from the assignable filter element. Instead of force a F applied oppositely, it is also possible to clamp the end side of the support tube 10 or to support it against a contact surface which is not shown, in order to then induce application of force by means of a suitable device (press) only from the opposite side. The forming process is in any case continued until the adjacent bead flanks 22 as shown in FIG. 2 come into contact with one another and in this respect can be produced without burrs.

Furthermore, the respective support ring 24 is a one-piece part of the contact surface 14 of the support tube 10 otherwise. Depending on the installation height of the respective support tube 10, the illustrated support rings 24 can be installed in multiples on top of one another, and for elements with a very small structure a support tube 10 also with only one bead 16 is to be used. Furthermore, for highly stressed locations in the support tube 10 several beads 16 can be made in the contact surface 14 in tight succession. Less stressed regions can also be left free of the stiffening rings, as illustrated. As shown in the figures, the respective bead 16 in addition to the support ring 24 is attached continuously peripherally in the support tube 10; but here it would also be conceivable to implement the arrangement only in segments or intermittently, for example, by a partial ring as the support ring 24 extending along the installation height on the contact surface 14, and arranged offset thereto in another plane, another partial ring (not shown). Since the overall height of the support tube 10 is changed by the application of a force F, it must be accordingly considered in the dimensioning of the installation length, i.e., for the desired installation length of the support tube 10 it must be chosen to be longer by a certain excess amount in order to have available a precision-fitted support tube 10 after forming, fundamentally its also being possible to shorten the projecting ends of the support tube 10 in order to obtain the desired length.

Preferably the support tube 10 consists first of all of a flat pre-cut piece of sheet metal or a sheet metal blank which when perforated is provided with the corresponding fluid passages 12 in the form of a perforation. The sheet metal part support tube 10 is then formed into a tube and the free ends are securely joined to one another, for example, by means of a welding or cementing process. But fundamentally it would also be possible to obtain a support tube 10 made preferably from plastic material in the form of an extrusion process, then shaping into the stiffening support rings having to be undertaken still within the softening state of the plastic material. The illustrated fluid passages 12 can then be made subsequently, whether by mechanical working or by way of a laser ablation process or the like. Accordingly, for the illustrated fluid passages 12 other cross sectional shapes can be used, with respect to the possible supporting action and the degree of desired fluid permeability the illustrated perforations having been found to be especially favorable.

The beads 16 can be rolled in, crimped or impressed by means of a tool which is not shown. Furthermore, as shown (FIG. 1), the bead cross section is first V-shaped or wedge-shaped and after the bead flanks 22 are placed on top of one another, a U-shaped formation results (FIG. 2); this distinctly reduces the notch action and is accompanied by the correspondingly high stabilities. Furthermore, it is also possible to make the indicated fluid passages 12 as shown, or optionally with other cross sectional shapes, in the support ring 24 in order in this way to increase fluid permeability.

Since for special constructions support tubes 10 can encompass the filter material both on the inner peripheral side and also on the outer peripheral side, in any case care must be taken that the respective bead 16 or support ring 24 projects with its free end in a direction that is not covered by the filter material itself. For a correspondingly pliable filter material, however, this free end can also engage the material; this is used to increase the longitudinal support on the support tube 10 and furthermore it would also be conceivable to insert the respectively specific filter material into the spaces between the two adjacent support rings 24 in order in this way to produce different filter properties in segments within the length of the support tube 10. As FIG. 2 shows, coating of the support tube combination shown there does not pose any problems and in particular uniform application of the respective coating material without drips would be ensured.

In another embodiment which is not detailed, it is also possible to route a free bead cross section in a V-shape in the form of a helix or other spiral along the support tube 10. By subsequently twisting the support tube 10 against the spiral direction, then the V-shaped bead flanks are placed on top of one another with the formation of a U-bead and in this way the bead geometry is stiffened.

The solution according to the invention leads to highly stiff support tubes which can be provided with very small wall thicknesses to be resistant to bulging in order to save material costs and weight in this way.

1. A method for producing a support part, in particular for use with a filter element which, provided with fluid passages (12), is shaped into a support tube (10) which on the peripheral side forms a contact surface (14) for a filter material, into which at least one bead (16) which divides the contact surface (14) into component contact surfaces (18) is annually placed, characterized in that while reducing the free bead cross section and with the formation of a support ring (24) the flanks (22) of the respectively assignable beads, which flanks are adjacently opposite one another, are placed on top of one another.

2. The method according to claim 1, wherein the indicated bead flanks (22) are placed on top of one another by means of axial application of a force (F) to the free ends of the support tube (10) which reduce their axial distance to one another in this regard.

3. The method according to claim 1, wherein the support tube (10) is shaped from a flat sheet metal or blank part which is provided with fluid passages (12) or is obtained by extrusion of a plastic material.

4. The method according to claim 1, wherein the beads (16) are rolled in, crimped or impressed.

5. The method according to claim 1, wherein the free bead cross section is made V-shaped and, after placing the bead flanks (22) on top of one another, U-shaped.

6. The method according to claim 1, wherein the fluid passages (12) are made in the contact surface (14) and preferably in the respective bead (16).

7. The method according to claims 1, wherein the respective bead (16) is placed on the outer peripheral side along the contact surface (14) such that the bead base points to the inside.

8. The method according to claims 1, wherein the support part including the respective support ring (24), having emerged from the free cross section of a bead (16), is provided with a coating.

9. A filter element with a support part, produced by means of a process according to claims 1, which, provided with fluid passages (12), forms a support tube (10) which on the peripheral side has a contact surface (14) for a filter material into which at least at least one bead (16) is annularly formed which divides the contact surface (14) into component contact surfaces (18), wherein the free bead cross section when reduced forms a support ring (24) in which the bead flanks (22) which are adjacent to one another lie on top of one another.
